(19) United States
(12) Patent Application Publication
(10) Pub. No.: US 2009/0271396 A1
(43) Pub. Date: Oct. 29, 2009

(54) METHOD AND APPARATUS FOR MEDIA CONTENT PROVISION

(76) Inventors: Daniel Hooker, Buckinghamshire (GB); Gareth Reakes, Buckinghamshire (GB); John Taysom, Buckinghamshire (GB)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 12/373,550

(22) PCT Filed: Jul. 13, 2007
(86) PCT No.: PCT/GB07/50404

§ 371 Date: Jan. 13, 2009

(30) Foreign Application Priority Data
Jul. 14, 2006 (GB) 06139729

(51) Int. Cl. G06F 17/30; G06F 3/048

(52) U.S. Cl. 707/5; 715/810; 707/E17.109

(57) ABSTRACT

Disclosed is a method of providing relevant media content to a user, comprising: storing static data relating to the user's personal profile; providing a choice of media items to the user and allowing the user to select at least one media item from the choice for inclusion in a single media entity to be provided to a media device of the user; selecting at least one relevant media item from a set of additional media items in dependence upon at least some of the static data and at least some of any metadata associated with the or each media item selected by the user; concatenating the at least one user-selected media item and the at least one selected relevant media item to form the single media entity; and sending the single media entity to the user's media device.

The present invention relates to a media content provision method and apparatus.

Among content providers, such as radio, video or television, media content is provided to consumers through media entities such as ‘podcasts’, music tracks and television programmes.

Targeted media content distribution involves placing media content where it is most likely to reach the audience desired by the media providers. By providing media content that, for example, will appeal to certain demographics, the total media package can be tailored to reach a particular group of people.

One of the main problems involved with providing media content is ensuring that the most relevant media reaches its desired audience. While surveys on television programmes may indicate a particular set of demographic groups are more likely to watch day time soap operas, for example, it is difficult to be more specific; to take into account such information as where they are located, what other interests they might have.

Matching content to the desired audience is therefore remarkably difficult, and leads to a significant technical challenge in implementing an effective, working system.

According to a first aspect of the present invention, there is provided a method of providing relevant media content to a user, comprising: providing a choice of media items to the user and allowing the user to select at least one media item from the choice for inclusion in a single media entity to be provided to a media device of the user; selecting at least one relevant media item from a set of additional media items in dependence upon at least some static data relating to a personal profile associated with the user and at least some of any metadata associated with the or each media item selected by the user; concatenating the at least one user-selected media item and the at least one selected relevant media item to form the single media entity; and sending the single media entity to the user's media device.

Selection of the at least one relevant media item may also be performed in dependence upon at least some of any dynamic data received from the user's media device, such as location, time and temperature.

The method may comprise providing at least one dynamic media insertion marker in the single media entity, and, after sending to the user's media device, providing a further relevant media item selected from the set of additional media items for insertion into the single media entity in dependence upon the dynamic media insertion marker. The further relevant media item may be inserted into the single media entity at the location of the dynamic media insertion marker, or at some other location determined or specified by the dynamic media insertion marker, or at some other predetermined location.

The at least one dynamic media insertion marker may be provided in the single media entity before sending to the user's media device.

The further relevant media item may be selected in dependence upon at least some of the static data.

The further relevant media item may be selected in dependence upon at least some of any metadata associated with the or each media item selected by the user.

The further relevant media item may be selected in dependence upon at least some dynamic data from the user's media device, such as location, time and temperature.

The selection of the at least one media item by the user may be carried out at the user's media device.

The method may comprise detecting whether a user-selected media item has been updated, and, if so, creating and sending a new single media entity to the user's media device, possibly including new relevant media items.

The method may comprise storing the single media entity.

The media device may be a mobile media device.

The steps may be performed at a server remote from the media device.

The method may comprise providing a media reader application to the user's media device for reading the single media entity.

The single media entity may be provided in a form that is readable only by the provided media reader application.

The single media entity may comprise a single physical file.

The single media entity may comprise a plurality of separate files, and the media reader application may be adapted to prevent the user from selecting or deselecting individual ones of the separate files for playback on the media device. Other functions of the media reader application may also be temporarily suppressed, for example, the fast forward function.

The data relating to the user's personal profile may comprise such information as the user's age, sex, interests, profession, earnings and shopping habits.

As set out above, it is possible to benefit from the present invention without a step of storing the static data; for example the method may comprise accessing the static data from a remote server where required.

According to a second aspect of the present invention, there is provided an apparatus for providing relevant media content to a user, comprising: means for storing static data relating to the user's personal profile; means for providing a choice of media items to the user and allowing the user to select at least one media item from the choice for inclusion in a single media entity to be provided to a media device of the user; means for selecting at least one relevant media item from a set of additional media items in dependence upon at least some of the static data and at least some of any metadata associated with the or each media item selected by the user; means for concatenating the at least one user-selected media item and the at least one selected relevant media item to form the single media entity; and means for sending the single media entity to the user's media device.

According to a third aspect of the present invention, there is provided a method of playing a single media entity produced by a method according to the first or further aspect of the present invention on a media device, comprising disallowing a user of the media device from directly selecting individual media items within the single media for playback.

According to a fourth aspect of the present invention, there is provided a program for controlling an apparatus such as a computer to carry out a method according to the first, third or further aspect of the present invention.

The program may be carried on a carrier medium.

The carrier medium may be a transmission medium.

The carrier medium may be a storage medium.

According to a fifth aspect of the present invention, there is provided an apparatus such as a computer programmed by a program according to the fourth aspect of the present invention.

According to a sixth aspect of the present invention, there is provided a storage medium containing a program according to the fourth aspect of the present invention.

According to a further aspect of the present invention, there is provided a method of providing relevant media content to a user, comprising: providing a choice of media items to the user and allowing the user to select at least one media item from the choice for inclusion in a single media entity to be provided to a media device of the user; concatenating the at least one user-selected media item and at least one dynamic media insertion marker to form the single media entity; sending the single media entity to the user's media device; and, after sending to the user's media device, providing at least one relevant media item selected from a set of additional media items for insertion into the single media entity in dependence upon the dynamic media insertion marker. The method may comprise, before sending to the user's media device, selecting at least one relevant media item from the set of additional media items in dependence upon at least some static data relating to a personal profile associated with the user and at least some of any metadata associated with the or each media item selected by the user; and concatenating the at least one user-selected media item and the at least one selected relevant media item to form the single media entity. A yet further aspect of the present invention provides apparatus comprising means for performing such a method.

Reference will now be made, by way of example, to the accompanying drawings, in which:

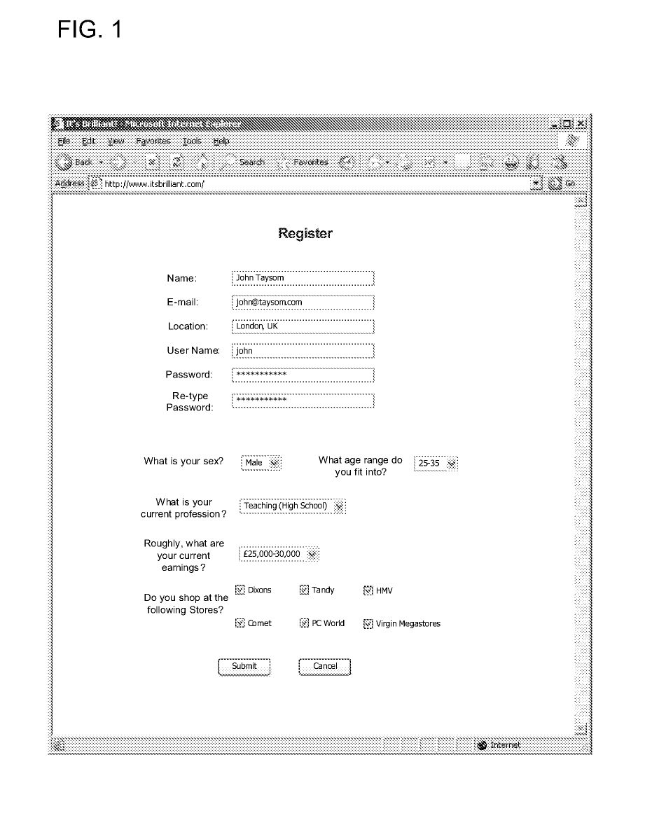

FIG. 1 illustrates an example interface for subscriber registration and for providing static data relating to the user's personal profile according to an embodiment of the present invention;

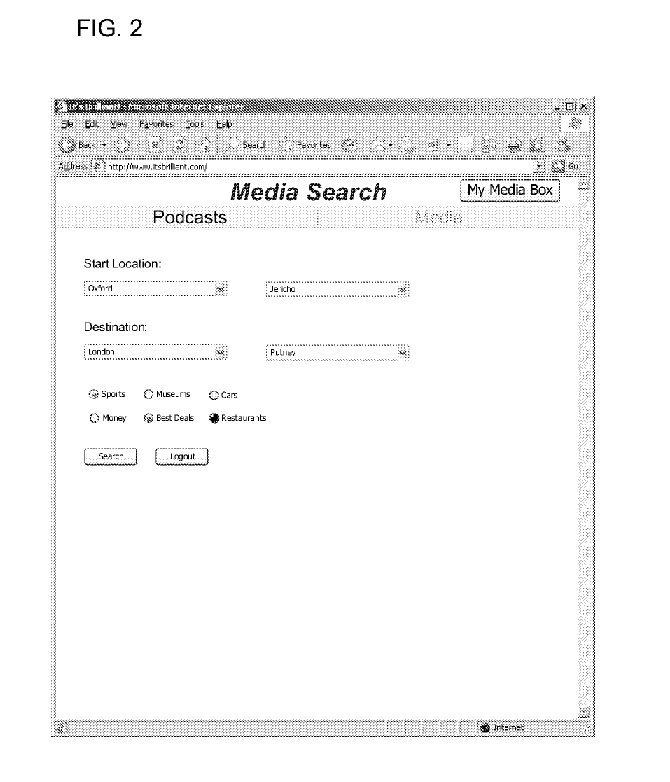

FIG. 2 illustrates an example interface for providing a choice of media items to the user and allowing the user to select at least one media item from the choice for inclusion in a single media entity to be provided to a media device of the user according to an embodiment of the present invention;

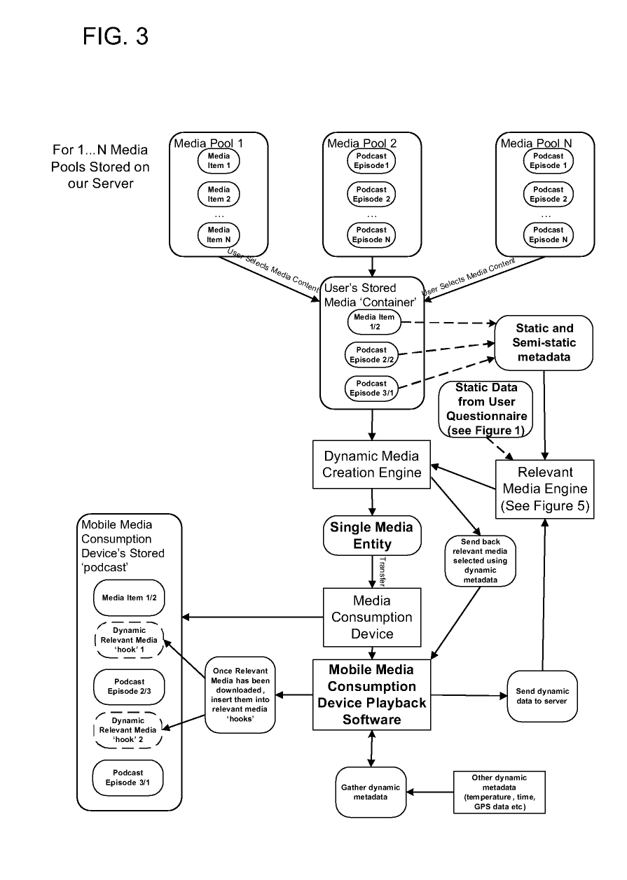

FIG. 3 is a block diagram illustrating a system and method for providing media content to a user according to an embodiment of the present invention;

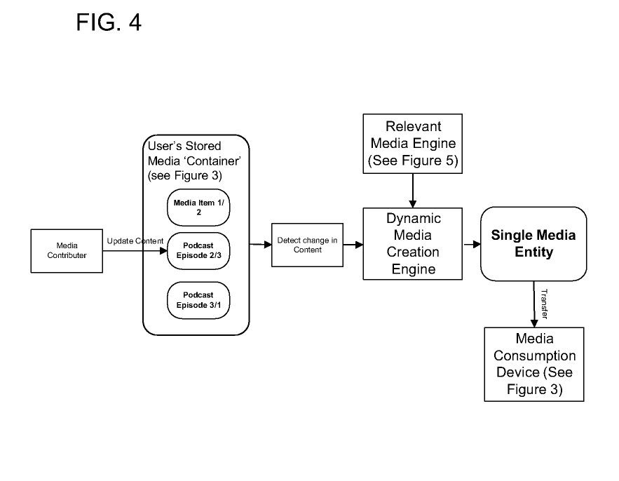

FIG. 4 is a block diagram illustrating a situation where the single media entity is automatically updated and transferred to the user's media device; and

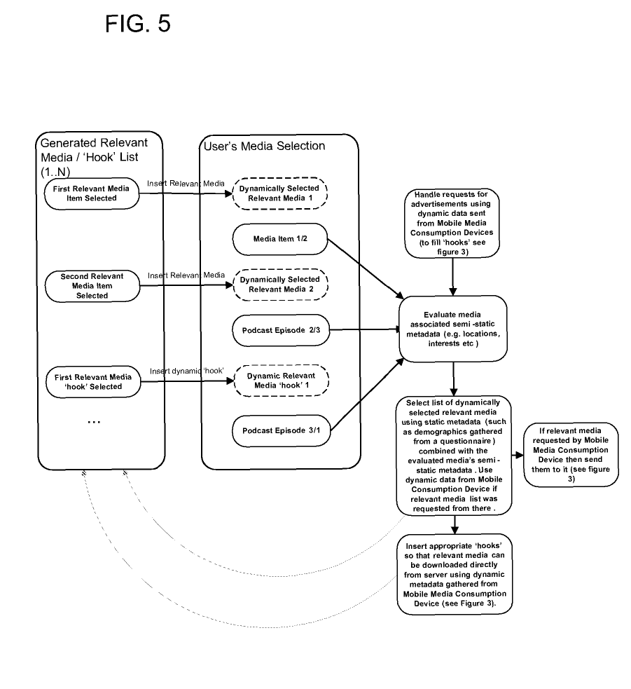

FIG. 5 is a block diagram illustrating operation of the relevant media engine of FIG. 3 in more detail.

An embodiment of the present invention proposes a method where ‘static’ data, such as demographics gathered from users who register with a system brand, can be combined with ‘semi-static’ data that is associated with a user's choice of media items, such as location and interest information. The data is ‘semi’ static because the choices made by the user relate to factors that are considered to be static over the perceived lifetime of the desired media entity, but may be different each time the user makes these choices. This combination of data is used to influence the selection of additional media items for inclusion in the eventual media entity provided to the user, along with those media items that the user him/herself has chosen. An example of this will be presented further below.

Such selection of additional media items can also be further influenced using ‘dynamic’ data that can be taken from the user's mobile media device (a mobile media device such as an iPod®). The media items selected can then be combined into a single continuous entity for users to enjoy, allowing highly accurately targeted relevant media items to be placed within it. The manner in which such data is gathered and then combined together has not been previously proposed.

Media items are in the form of digital binary files and are provided from media contributors, preferably via the Internet, to be available for selection by users. The files selection by the user can be combined together, with targeted relevant media items (in the form of digital binary files) inserted into them, by a method embodying the present invention, and sent (when requested) to an individual user (subscriber) and transferred as a single media entity onto their mobile media device. On each media device, there may be an application downloaded by the user and transferred to their device that reads, executes, or plays back the single media entity that was transferred.

A list of predetermined ‘hooks’ or ‘markers’ can also be provided within the file that can later be used to insert additional binary files. When the application detects that the device has reached one of the predetermined ‘markers’ within the file during playback, dynamic data (such as GPS location, temperature and local time) are sampled from sensors/internal instruments on the device and sent back to the remote server, where they are used to select a digital binary file which is then transferred back to the mobile device and inserted at the ‘marker’ that triggered the transfer. This process continues for each ‘marker’ within the file.

FIG. 1 shows a typical subscriber registration with a system embodying the present invention. In FIG. 1, users can subscribe to the service via a remote server, by selecting a particular brand and answering a questionnaire that ascertains demographics or user profile information relating to the user. This data is stored and used as static data for the selection of relevant data in the relevant media engine described below with reference to FIGS. 3 to 5 (FIG. 5 in particular). The contents of this questionnaire and hence the nature of the static data is typically determined by a ‘brand manager’, someone that manages content providers and the way that such content is provided to users. They can configure which questions get asked and hence the type of static data that is used by the relevant media engine.

FIG. 2 shows a typical subscriber searching for media content via the remote server. The searches for and select media content stored on, or accessible by, the server, by inputting semi-static information such as geographic locations and interests. This is correlated with metadata associated with each of the media items available for selection so as to provide a list of media items to the user for selection. The semi-static metadata itself is typically first defined by brand managers and then later selected by content providers and associated with media. When a user selects such media, the semi-static metadata associated with their selection is combined with static metadata already ascertained in FIG. 1 and used by the relevant media engine (see the description relating to FIG. 5, in particular).

Preferably, the server will run a Web application that allows users to interact with the system via the World Wide Web. Users would be able to interact with the system anywhere in the world with the aid of a web browser, whether it be from a desktop machine or from their mobile media device, or any other type of system.

FIG. 3 shows an overall system view of an embodiment of the present invention. Individual media elements stored on the remote server are selected by a user and placed in a collection or ‘media container’ and then transferred (downloaded) to their mobile media device as a single media entity. The device then uses dynamic data such as temperature, time and GPS location to dynamically select relevant media from the remote server and insert them into existing media entities, placing them at predefined ‘hooks’ or ‘markers’.

In FIG. 3, the selected media elements are placed into a user's stored media container and each element is concatenated with the next one to form a single media entity. This may be done in a similar way, for example, to the way film is spliced together. The media entity is then transferred from the remote server to their mobile media device. Inserted between those media elements selected by the user, are relevant media items selected by the relevant media engine, using static data gathered from the user questionnaire (see FIG. 1) and semi-static metadata that is attached to the selected media elements.

Placed into the single media entity in this embodiment are predetermined ‘hooks’ or ‘markers’. An application is downloaded by the user and transferred to their media device, which executes or ‘plays back’ the single media entity. When these locations within the entity are encountered during the playback, the application triggers the sampling and transfer of dynamic data from the device's local environment (such as local time, temperature, GPS information) to our server which is then fed into the relevant media engine (see FIG. 5). The relevant media engine combines this data with the existing static and semi-static data to choose a more accurately selected media item than would be selected without the dynamic data. This media item is then sent back to the subscriber's media device and inserted by our software at the appropriate place before being played back as part of the single media entity. Dynamic data can also be used in this way to replace an existing media item with a new media item if it is considered more appropriate.

FIG. 4 shows a media contributor updating their content and a subscriber's stored single media entity being automatically updated and transferred to the mobile media device from our server. In FIG. 4, subscribers have the contents of their stored media containers automatically updated when media providers update the media elements that they provide. A subscriber's stored container is updated and dynamically recombined using the dynamic media creation engine into a new single media entity, and delivered to the subscriber's mobile media device.

FIG. 5 shows in more detail how the relevant media engine is used to create the single media entities on the remote server, and how static data and semi-static metadata are used to insert relevant media into them, and how ‘hooks’ or ‘markers’ are placed into it. Relevant media can then be downloaded dynamically using additional dynamic data from the user's mobile media device once the single media entity has been initially downloaded.

In FIG. 5, the relevant media engine combines the static metadata associated with the individual subscribers (as shown in FIG. 1) and semi-static metadata gathered from media items selected by them, together with dynamic data relayed to it by their mobile media device. It then uses this to insert carefully targeted relevant media into the single media entity, thus ensuring that subscribers are delivered media that is most relevant to them.

In the above-described embodiment, a single media entity is described as being delivered to the user. A single media entity, is required because providers of additional media items (such as advertisers) desire that their content cannot easily be skipped over during playback on user devices. Sending the media items as separate files with an associated playlist, for example, would allow users to use conventional playback software to skip over the media items selected for inclusion alongside those chosen by the user.

From a practical point of view, a single physical file for the media entity is easier to maintain, rather than maintaining multiple files and play lists. Nevertheless, it is not essential that the single media entity is provided as a single physical file. What is important is the perception from the point of view of the user. It is immaterial whether the single media entity is made up from a single or multiple files, as long as the user sees it and uses it essentially as a single entity. If the entity is to be spread over many files then it is desirable to ensure that users cannot simply play them (or choose not play them) individually, for example by providing a dedicated playback application that disallows this sort of activity. The effect would be the same as having a single file.

As can be appreciated from the above, an embodiment of the present invention provides a significant technical contribution in the manner that allows media items to be selected, additional relevant media items to be chosen based on a variety of different data sources and gathered from additional media content providers, brought together into a single media entity, and distributed to the user, as well as updated based on data for example provided from physical real-time data taken from the media devices.

As described above, a method embodying the present invention allows the selection of content from a wide choice of content held upstream of a device (or application on a device), either somewhere else on-site or off-site or both. The selection of the content in the manner described causes the content to have appended to it and placed with it within a resulting single media entity other relevant media determined by a method according to an embodiment of the present invention, based on a behavioural model of past and future users. The relevant media cannot easily be removed from the user-selected content because it is within a single media entity.

In essence, the content and the relevant media appended to it is analogous to a magazine where the content is assembled and then ‘glued’ or ‘stapled’ together by the publisher. With an embodiment of the present invention, however, the selection of the content is performed by an individual rather than by a central publication function. Versions of the method will actually append the relevant media before or at the time of the download. The relevant media content may be on site or off site or both. Other versions will append pre-determined ‘valences’, ‘hooks’ or ‘markers’ derived from the behavioural model(s) to the relevant media that will itself be appended only at the time the content is consumed. This ‘late binding’ of the relevant media with the content within a single media entity is specifically enabled by a method and apparatus embodying the present invention.

In addition, an embodiment of the present invention allows the user who selected the content (or an application under his or her control) to share the resulting single media entity by passing it along to another user. Subsequent users will by their actions, as if they were the first user, cause the ‘late binding’ of relevant media that is ‘relevant’ to them and not that which is/was relevant to the first user. The result is a sort of ‘virtual digital multimedia magazine’ where the content is largely selected individually but in part is caused to be appended by the method and apparatus, the physical location of the content and the relevant media being irrelevant. The system can also adapted to detect that the media entity is in the hands of a new user, for example through a registration process which may be automatic, and begin to base relevant media item selections on the personal profile of the new user rather than the original user. The new personal profile can either be inferred, e.g. through analysing the behaviour of the new user, or explicit, e.g. through a registration process similar to that described above.

These are significant advantages provided by the technical selection, binding and consumption process underlying an embodiment of the present invention.

It will be appreciated that a user may select the media items for inclusion in the single media entity from one device and have the single media entity delivered to another media device. Reference to “the user's media device” does not imply ownership of the media device by the user, but merely that the media device is chosen by the user to receive the single media entity.

It will be appreciated that, although the above embodiment has been described mainly in relation to the delivery of media content to a mobile media device, the device need not be mobile; it could, for example, be a desktop PC or a digital interactive TV system or any other type of media device.

It will be appreciated that operation of one or more of the components of an embodiment of the present invention can be controlled by a program operating on a media device or server apparatus. Such a program can be stored on a computer-readable medium, or could, for example, be embodied in a signal such as a downloadable data signal provided from an Internet website. The appended claims are to be interpreted as covering a program by itself, or as a record on a carrier, or as a signal, or in any other form.

1. A method of providing relevant media content to a user, comprising:
storing static data relating to the user's personal profile;
providing a choice of media items to the user and allowing the user to select at least one media item from the choice for inclusion in a single media entity to be provided to a media device of the user;
selecting at least one relevant media item from a set of additional media items in dependence upon at least some of the static data and at least some of any metadata associated with the or each media item selected by the user;
concatenating the at least one user-selected media item and the at least one selected relevant media item to form the single media entity; and
sending the single media entity to the user's media device.

2. A method as claimed in claim 1, wherein selection of the at least one relevant media item is also performed in dependence upon at least some of any dynamic data received from the user's media device, such as location, time and temperature.

3. A method as claimed in claim 1, comprising providing at least one dynamic media insertion marker in the single media entity, and, after sending to the user's media device, providing a further relevant media item selected from the set of additional media items for insertion into the single media entity in dependence upon the dynamic media insertion marker.

4. A method as claimed in claim 3, wherein the at least one dynamic media insertion marker is provided in the single media entity before sending to the user's media device.

5. A method as claimed in claim 3, wherein the further relevant media item is selected in dependence upon at least some of the static data.

6. A method as claimed in claim 3, wherein the further relevant media item is selected in dependence upon at least some of any metadata associated with the or each media item selected by the user.

7. A method as claimed in claim 3, wherein the further relevant media item is selected in dependence upon at least some dynamic data from the user's media device, such as location, time and temperature.

8. A method as claimed in claim 1, wherein the selection of the at least one media item by the user is carried out at the user's media device.

9. A method as claimed in claim 1, comprising detecting whether a user-selected media item has been updated, and, if so, creating and sending a new single media entity to the user's media device.

10. A method as claimed in claim 1, comprising storing the single media entity.

11. A method as claimed in claim 1, wherein the media device is a mobile media device.

12. A method as claimed in claim 1, wherein the steps are performed at a server remote from the media device.

13. A method as claimed in claim 1, comprising providing a media reader application to the user's media device for reading the single media entity.

14. A method as claimed in claim 13, wherein the single media entity is provided in a form that is readable only by the provided media reader application.

15. A method as claimed in claim 1, wherein the single media entity comprises a single physical file.

16. A method as claimed in claim 13, wherein the single media entity comprises a plurality of separate files, and wherein the media reader application is adapted to prevent the user from selecting or deselecting individual ones of the separate files for playback on the media device.

17. A method as claimed in claim 1, wherein the data relating to the user's personal profile comprises such information as the user's age, sex, interests, profession, earnings and shopping habits.

18. An apparatus for providing relevant media content to a user, comprising:
means for storing static data relating to the user's personal profile;
means for providing a choice of media items to the user and allowing the user to select at least one media item from the choice for inclusion in a single media entity to be provided to a media device of the user;
means for selecting at least one relevant media item from a set of additional media items in dependence upon at least some of the static data and at least some of any metadata associated with the or each media item selected by the user;
means for concatenating the at least one user-selected media item and the at least one selected relevant media item to form the single media entity; and
means for sending the single media entity to the user's media device.

19. A method of providing relevant media content to a user, comprising:
providing a choice of media items to the user and allowing the user to select at least one media item from the choice for inclusion in a single media entity to be provided to a media device of the user;
concatenating the at least one user-selected media item and at least one dynamic media insertion marker to form the single media entity;
sending the single media entity to the user's media device; and
after sending the single media entity to the user's media device, providing at least one relevant media item selected from a set of additional media items for insertion into the single media entity in dependence upon the dynamic media insertion marker.

20. A method as claimed in claim 19, comprising, before sending the single media entity to the user's media device, selecting at least one relevant media item from the set of additional media items in dependence upon at least some static data relating to a personal profile associated with the user and at least some of any metadata associated with the or each media item selected by the user; and concatenating the at least one user-selected media item and the at least one selected relevant media item to form the single media entity.

21. An apparatus for providing relevant media content to a user, comprising:
means for providing a choice of media items to the user and allowing the user to select at least one media item from the choice for inclusion in a single media entity to be provided to a media device of the user;
means for concatenating the at least one user-selected media item and at least one dynamic media insertion marker to form the single media entity;
means for sending the single media entity to the user's media device; and
means for providing, after sending the single media entity to the user's media device, at least one relevant media item selected from a set of additional media items for insertion into the single media entity in dependence upon the dynamic media insertion marker.

22. A method of playing a single media entity produced by a method as claimed in claim 17 on a media device, comprising disallowing a user of the media device from directly selecting individual media items within the single media for playback.

23. A program for controlling an apparatus to carry out a method as claimed in claim 17.

24. A program as claimed in claim 23, carried on a carrier medium.

25. A program as claimed in claim 24, wherein the carrier medium is a transmission medium.

26. A program as claimed in claim 24, wherein the carrier medium is a storage medium.
